(19) United States
(12) Patent Application Publication
(10) Pub. No.: US 2025/0217104 A1
(43) Pub. Date: Jul. 3, 2025

(54) SORTABLE HEAT MAP

(71) Applicant: JP Morgan Chase Bank, N.A., New York, NY (US)

(72) Inventors: Bradley H. CRUSE, Rowlett, TX (US); Zachary HOWELL, Denton, TX (US); Uri KLEIN, New York, NY (US)

(73) Assignee: JP Morgan Chase Bank, N.A., New York, NY (US)

(21) Appl. No.: 18/399,454

(22) Filed: Dec. 28, 2023

(51) Int. Cl. G06F 7/08; G06F 3/04817; G06F 40/177

(52) U.S. Cl. CPC G06F 7/08; G06F 3/04817; G06F 40/177

(57) ABSTRACT

Provided is a system and method for reordering a heat map. A specific row or column of the heat map is selected by a user (a viewer of the heat map). The user also indicates that the map is to be sorted in ascending order or descending order of intensity according to a selected row or selected column. A revised heat map is constructed in video memory by first sorting the selected row (or selected column) in ascending or descending order by intensity. This generates a mapping order for application to cells in other rows (or columns). The other rows (or columns) are then re-ordered according to the mapping. The revised heat map is then presented via the display.

### FIELD OF TECHNOLOGY

The present disclosure generally relates to graphical user interfaces for data display. More particularly, the present disclosure relates to the display and sorting of a heat map.

### BACKGROUND

A heat map is a graphical display of the intensity of a measured or calculated value referred to generically as “heat.” In practical application, the measured or calculated value may take a wide variety of forms. For example, heat may be the actual temperature of some physical environment. However, the heat may also be the intensity of any of a wide variety of other phenomena, some of which may be physical (e.g., measured pressures, radiation intensities, light intensities, wind speeds, etc.). The heat may also be one of numerous non-physical phenomena which may be determined via various calculations, for example: performance ratings on a job, student grades, employment rates, etc. In a financial context, the heat may be a measure of bank interest rates, mortgage rates, credit card default rates, percentages of increase or decrease of stock values, or any number of other financial parameters.

For purposes of a heat map, the heat (illustrated via a map) is generally a function of two designated variables. Using again financial contexts as examples: Credit card default rates (the heat value) may be determined as a function of two variables-(i) the credit card holder's economic status (which may for example be on some percentile ranking from lowest 1% to the 100th percentile); and (ii) geographic location (which may for example be specified by zip codes, or states, or a matrix of paired latitude/longitude ranges, or in other ways).

Similarly, stock value increase/decrease (the heat, over some designated time period) may be determined as a function of two variables—(i) different industries/industry sectors (which may be designated according to some standard industry classification scheme, such as Standard Industrial Classification (SIC) codes or North American Industry Classification System (NAICS)); and (ii) the size of corporations (in revenue, or in total valuation, or other metrics).

Many other forms of “heat,” dependent on many different pairs of independent variables, may be envisioned. Heat maps in general may be displayed in printed matter or on computer display screens. However, for purposes of the present disclosure a heat map refers to a graphical map presented dynamically via the display of a computer system, and which may be updated in real time via the computer system.

Various display colors, shading, or graphical patterns, which may be referred to as data indicia, may be used to indicate different levels of heat intensity, typically over a rectangular area defined by two orthogonal axes. Two orthogonal axes typically represent the two independent variables. Heat maps are useful tools for a skilled expert in the relevant field(s) to visually “pick out” patterns in the heat data.

Currently, heat maps, even those presented on computer displays, are in one substantial sense static: While they may be updated in real time to reflect changing data, they are not subject to user interactions to help highlight various patterns in the data which may initially be elusive to the human eye. The view presented is a fixed view.

### SUMMARY

Traditional data heat maps present the data “as is.” While they depict the strength of the relationship between the two sets of variables, any detailed exploration of one variable's relationship to an axis requires human short-term memory to visualize an understanding of how that relationship compares to another variable's relationship to another axis. Computer generated heat maps may be updated over time in response to changing input data. However, for a given, static, fixed input data set, the resulting fixed-view heat map does not readily lend itself to answering questions such as “What are the strongest relationships? The weakest?” Further, the larger the data sets on each axis, the more difficult the short-term memory task becomes.

Providing the ability to actively sort the heat map on a variable of interest improves user ability to explore the data relationships while reducing cognitive load for the human viewer. Given the aforementioned deficiencies, systems and methods for sorting the heat intensities displayed on a heat map are disclosed.

Under certain circumstances, an embodiment of the present disclosure provides a method including rendering, via a computer processor, a heat map including a vertical axis with a first data range, a horizontal axis (i) with a second data range and (ii) orthogonal to the vertical axis, and a plurality of cells arranged in an initial grid along the vertical and horizontal axes. Each cell of the plurality of cells displays a data indicia indicative of a results data value responsive to (i) a first data value within the first data range and (ii) a second data value within the second data range, the plurality of cells being arranged in a plurality of rows and columns. The method also includes selecting, via the computer processor, one of a single sorting column or a single sorting row of the initial grid; sorting the plurality of cells of the selected single sorting column or the single sorting row according to a data indicia order, the sorting generating a mapping order; sorting in the initial grid, according to the generated mapping order, one of (i) each column of the initial grid different than the single sorting column, or (ii) each row of the initial sorting grid different than the single sorting row; and rendering a revised grid via the processor, the revised grid including the initial grid.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1 illustrates an exemplary block diagram of a computer system with a graphical display upon which embodiments of the present disclosure may be practiced.

FIG. 2 illustrates an exemplary heat map constructed and arranged in accordance with the embodiments.

FIG. 3 illustrates an exemplary sorting of a heat map from an initial heat map to a revised heat map, in accordance with the embodiments.

FIG. 4 presents a flow chart of an exemplary sorting of a heat map, in accordance with the embodiments.

FIG. 5 illustrates an exemplary heat map with ordering widgets, in accordance with the embodiments.

### DETAILED DESCRIPTION

This disclosure describes systems, apparatuses, and methods related to sorting a graphical display of a heat map image with static or fixed source data.

In the following detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process, electrical, and structural changes may be made without departing from the scope of the present disclosure.

In the embodiments, the underlying software of the generation and modification of the heat map could be generically constructed for integration into any type of mobile or desktop platform hardware or electronic device (e.g., smart phone, desktop/laptop computer, tablet computer etc.). For example, the heat map could be bundled into an application kit for integration into Android's operating system (OS), into an applet for a browser web page, or for use as a stand-alone application under Microsoft Windows or Apple's iOS.

The sorting methods disclosed herein may be applied equally to the sorting of rows of a heat map or columns of a heat map. For convenience of exposition and clarity, some embodiments discuss sorting by rows, but the row and column elements could be reversed for an embodiment which sorts by columns. Similarly, and again for convenience and clarity only, some embodiments discuss sorting by columns, but the row and column elements could be reversed for an embodiment which sorts by rows.

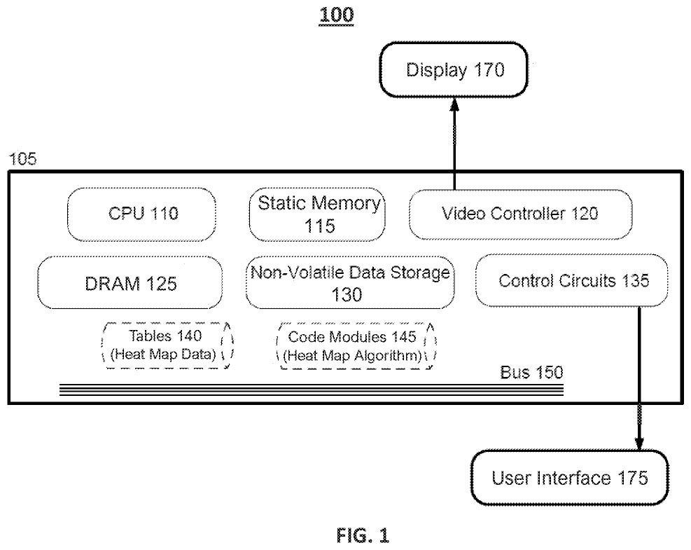

FIG. 1 is a block diagram of an exemplary computer system 100 which may be employed to practice the embodiments of the present disclosure. The computer system 100 may be, for example and without limitation a desktop computer, a tablet computer, a cell phone, a supercomputer, or similar.

The computer system 100 may implement or execute, for example, computer code (software or firmware) which enables the graphical display of information on a graphical display 170, according to methods described further below in this document.

The computer system 100 may contain a motherboard 105. The motherboard 105 typically holds and interconnects various components 110-135 which may be microchips or physical disk drives or similar. The components 110-135, discussed in greater detail below, enable at the hardware level, operation of the computer system 100, code modules 145, and execution of operations related to the embodiments.

The computer system 100 includes hardware microprocessor, also known as a central processing unit (CPU) 110, providing for overall operational control of the computer system 100. This operational control includes but is not limited to receiving data from data files or from connections to other computers and interacting with static memory 115. The CPU 110 may also control video controller 120, dynamic random access memory (DRAM) 125, non-volatile data storage (NVDS) 130, and control circuits 135. The CPU 110 may be configured via static memory 115 and code modules 145 to perform arithmetic and logical operations necessary for implementation of the embodiments.

The static memory 115 may store non-volatile operational code, including but not limited to operating system code, computer code for locally processing and analyzing data, and computer code which may be used specifically to enable the computer system 100 to implement the embodiments described herein. By way of example, the CPU 110 may execute computer code stored in the static memory 115, and/or the code modules 145 to implement the various aspects of the embodiments.

Video controller 120 provides an interface between the CPU 110 and a display 170 and facilitates the display of both graphics and text on the display 170.

Control circuits 135 may perform a variety of tasks, including data and control exchanges, as well as input/output (I/O) tasks, network connection operations, control of the bus 150, and other tasks generally known in the art of processing systems. The control circuits 135 may include a mouse controller, keyboard controller, touchpad controller (not shown in the figure) to support the operations of one or more user interfaces 175 configured to receive input from a user. In some embodiments, the display 170 may be a touch-screen display, thus including functionality of both a display and a user-interface. The control circuits 135 may also support such functions as external I/O (e.g., via universal serial bus (USB) ports, an Ethernet port, wireless communications, etc.).

DRAM 125 may be used to temporarily store data or program code, or code modules 145. The code modules 145 may store the necessary computer code to perform the data manipulations and video display effects described further below in this document. DRAM 125 may also be used to temporarily store some or all of the code from static memory 115. DRAM 125 may also be used to temporarily store tables 140 or similar data or data structures which are used as the data foundation to construct heat maps described below.

The NVDS 130 may take the form of hard disk drives, solid state drives (including flash drives and memory cards), magnetized tape, digital video disc (DVD) or similar. The DRAM 125 and the NVDS 130 may be referred to in the appended claims collectively as memory.

A system-supporting bus 150 provides for data communications between the CPU 110, the static memory 115, the DRAM 125, the video controller 120, the NVDS 130, and the control circuits 135.

Persons skilled in the relevant arts will recognize that in general, data processing may be implemented and performed via (1) dedicated hardware (e.g., task-specific signal processors), (2) via a combination of general purpose processing hardware (e.g., microprocessors) and computer instructions (code) which may be stored in static memory, volatile memory, and/or non-volatile memory 120, or (3) combinations of categories (1) and (2) above. Throughout this document, the term CPU generally refer to any of categories (1), (2), and (3) above. For example, the present system and method may be implemented in whole or in part via a graphics processor (not shown the figure), which for present purposes is subsumed under the term central processing unit.

Fixed-view heat maps are known in the art, and the details of the digital construction of a graphical heat map image in the memory from underlying raw data is not a primary focus of the present document. By way of example only, one possible method of generating in memory a graphical heat map 200, 300, 500 based on tabular data stored in the DRAM 125 is presented herein.

The raw data or independent data for the heat map image, stored for examples in the tables 140, may consist of vertical-axis data with a range of first data values (first data range), horizontal-axis data with a range of second data values (second data range), and specific table data entries of dependent third data values which each depend on the first data values and second data values. The third data values are the heat values, which are generally understood as some measure of an intensity of a phenomena dependent on the first data values and the second data values.

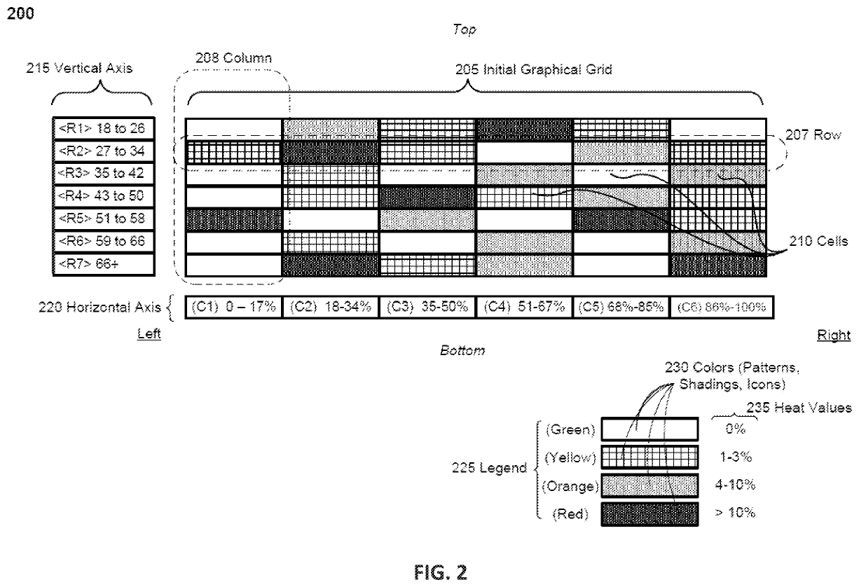

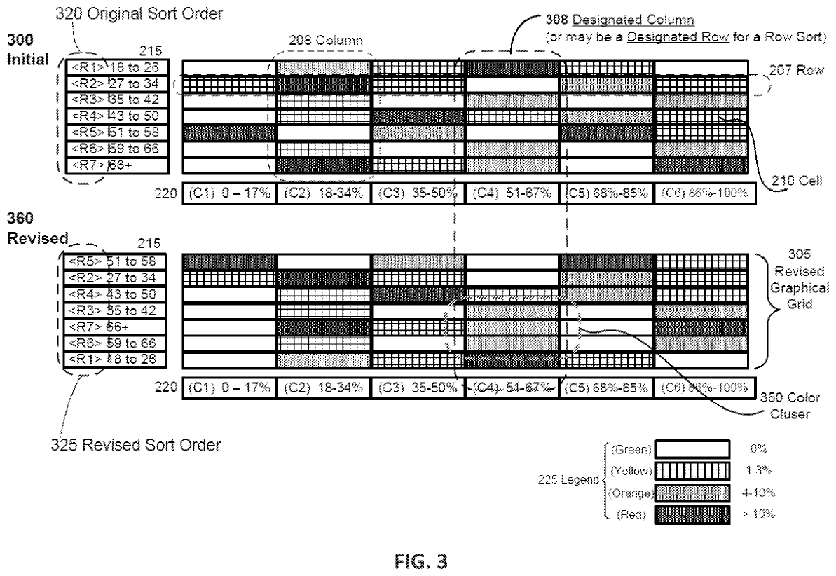

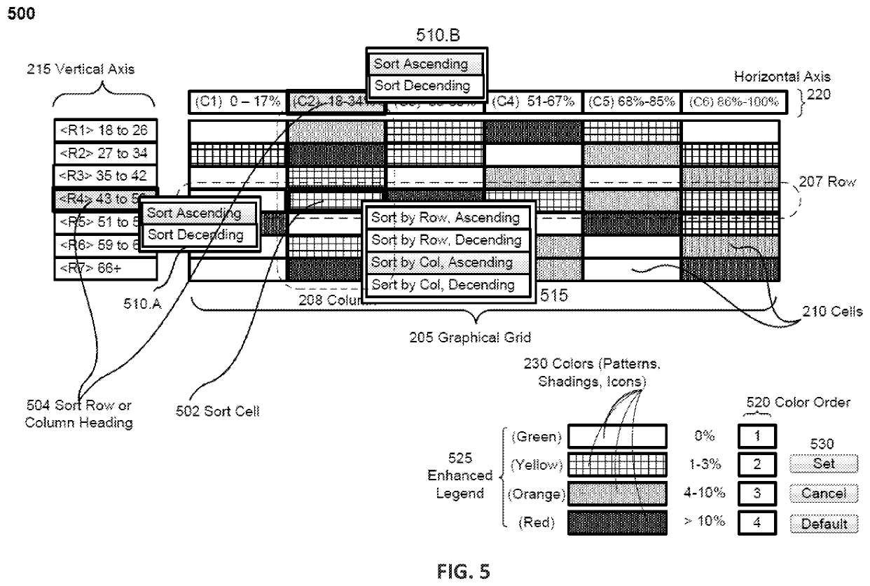

The third data values may be arranged or stored in memory in a data structure indicative of a column and row form, or which can be transformed into a tabular (column and row) form. For purposes of generating an image representative of a heat map 200 (e.g., see FIG. 2), 300 (e.g., see FIG. 3), 500 (e.g., see FIG. 5) each data table entry may be associated with designated, specific unique pairing of a specific number in the first data range and a second specific number in the second data range. Third data values, or heat values, or designated ranges of third table values, are also associated (mapped) in memory with specific display colors 230, display textures, icons, or similar data indicia (the term “colors” is predominantly used in this disclosure, while the term “data indicia” is used in the appended claims):
a specific color→all third data values in range (x, y), x<=y
heat data value (first data (m), second data (n))→specific color

Where, x<=heat data value (first data (m), second data (n))<=y.

With reference to FIG. 2, a rectangular, tabular data display is then constructed in video memory in DRAM 125 or NVDS 130 with a vertical axis 215 for the first data values and a horizontal axis 220 (which is orthogonal to the vertical axis) for the second data values. Suitable colors 230 are assigned to rectangular cells 210 to represent heat values 235 (i.e., heat value ranges), as well as a legend 225, are constructed in memory to indicate the association between the display colors 230 and the heat values 235.

The legend 225 may be presented in an ascending or descending order of the heat values 235. In FIG. 2, a heat map 200 includes a graphical initial grid 205 represents an exemplary display of heat data display including the horizontal axis 220 and the vertical axis 215, along with the legend 225. The heat map 200 may then be transferred via the video controller 120 for presentation via the display 170.

By way of example, the heat map 200 of FIG. 2 may have six columns 208 and seven rows 207 (i.e., 6×7 matrix). Heat maps constructed according to embodiments of the present disclosure, however, are not limited to a 6×7 matrix and may readily include dozens, hundreds, or thousands of rows 207 and/or columns 208.

The exemplary heat map 200 may be a display of rectangular cells 210 that are adjacent to each other and arranged in a graphical grid 205, with rows 207 of cells 210 and columns 208 of cells 210. The use of rectangular cells 210 is exemplary only. Other cell shapes, such as diamonds, squares, circles, or ovals are within the spirit and scope of the present disclosure. In a finely detailed, high resolution heat map with large amounts of data, the cells 210 may each be just a few display pixels in width or height, or even a single display pixel in size.

In the example of FIG. 2, each of the sales 210 will be characterized by being filled by a specific color 230, shading of color, or pixel pattern (e.g., data indicia), indicated by the legend 225. (For cells that are a single pixel in size, the shading or pixel pattern may be various specific colors or intensities for the individual pixels.) The colors 230 are commonly employed in the art, with different colors 230 representing different data values for heat (results data values) or representing non-overlapping ranges of data values for heat.

For purposes of illustration, different patterns are used in FIG. 2 to represent different intensities. In the exemplary heat map 200, a cell 210 (e.g., white colored) could represent a lowest data value or data intensity. In an actual color representation on the display 170, the “white” might be mapped to and displayed as the color green (which may conventionally indicate a normal state or baseline state of some system or phenomena). Similarly, successive patterns of shading could be mapped to and displayed as different colors 230 such as yellow, orange, and red, which are represented by general conventions of successively greater intensities of a state of some system or phenomena (e.g., “red” often indicates an emergency state). However, other schemes of colors 230 may be employed.

In alternative embodiments, a same hue (i.e., same color 230), such as blue only, or green only, may be employed for all cells, but with different shadings from light to dark (e.g., white to light blue to dark blue) to represent different levels of heat values 235 or non-overlapping ranges of heat values 235. For purposes of this document, the term color 230 will be employed, while the fill of the cells 210 may instead, or additionally, be a pattern, texture, degree of shading, or even an icon, or brief explanatory text or numbers. The sales 210 with a common color 230 fill represent the same heat value within the heat values 235 or common (shared) range. Eni two cells 210 having a different color 230 (fill, shading, etc.) represent different and mutually exclusive amounts of heat or different and mutually exclusive ranges of heat.

The exemplary heat map 200 illustrated may be indicative of any number of different kinds of phenomena. For example, the vertical axis 215 may represent age ranges of persons of the United States of America, and the horizontal axis 220 may represent income earners categorized according to their percentile ranking of earned income. Each cell 210 may represent (i) a percentage of citizens in a given age range and a given income bracket who are late on making credit card payments, (ii) a percentage of citizens in a given age range and a given income bracket who are late on making mortgage payments, or (iii) other indicators of economic performance. For example, economic performance may include employment or categories of employment assigned hierarchical values. Categories, for example, may include home owners and types of homes owned (“rented unit”, “condominium one bedroom”, “condo two bedrooms”, “private home one bedroom”, “private home two bedrooms” etc.) that are assigned hierarchical values for citizens in a given age range and/or income bracket.

Thus, the heat in the exemplary heat map 200 of FIG. 2 may be a measure of an economic intensity or level of achievement characteristic of a selected group of people, as a function of two independent variables: age ranges and income level. Persons skilled in the relevant arts will recognize that many other independent variables may be employed, along with many other appropriate forms of intensities for the heat dependent on the two independent variables.

The heat map 200 may be displayed on display 170 of computer system 100, in accordance with video display instructions issued by video controller 120 operating under control instructions from CPU 110. In turn, the CPU 110 may issue the video control instructions based on suitable code modules 145 and based on data from tables 140; the data in tables 140 (or other data structures) provides the basis for data displayed in vertical axis 215, horizontal axis 220; and where the data in tables 140 may be also provide the basis for the heat values 235 displayed in cells 210, as mapped to suitable colors 230 of heat or icons or shadings of heat, as shown in the legend 225.

As noted above, the legend 225 typically provides a default value ordering of colors 230, ascending or descending heat intensity. In the exemplary heat map 200, the colors 230 are listed in an ascending order (from top to bottom) as green, yellow, orange, and red, with green being the lowest heat and red being the highest heat. Other schemes of colors 230 may be employed. For example (noted above), to visually highlight different heat intensities, a single hue of color may be employed with lighter shadings (low color saturation) of the hue indicating low heat and darker shadings (high color saturation) indicating higher heat.

FIG. 3 illustrates, by way of example, transformation of an exemplary first heat map 300 to an exemplary second or revised heat map 360. The heat map 300 may be the same or substantially the same as heat map 200 of FIG. 2. The heat maps 300 and 360 share a common legend 225. As depicted, the heat maps 300 and 360 present identical data in the form of corresponding cells 210. However, in the heat map 360, the horizontal ordering of the data has been modified in comparison to the horizontal ordering of data in the heat map 300, as discussed further below.

In particular, and with reference initially to the columns 208 of table 300, the cells of each column 208 of table 300 have no apparent ordering with respect to higher or lower heat values 235. The heat values 235 of table 300, as indicated by the colors of cells 210, simply reflect the data of tables 140 (not shown in the figure); and so the cells 210 are ordered vertically, from top to bottom, by their dependence on the heat values 235 in vertical axis 215. In turn, vertical axis 215 has a default ordering from lowest to highest heat values 235 going from top to bottom. In an alternative embodiment, the vertical axis 215 may have a default ordering from highest to lowest values, or other default ordering, as assigned programmatically. Depending on the data set, the result may be that the vertical ordering of heat values 235 in each column 208 may appear to be substantially random.

With reference now to revised heat map 360, the same heat values 235 are presented as shown in the initial heat map 300 and presented with respect to the same independent data in vertical axis 215 and horizontal axis 220. However, the heat values 235 in a revised graphical grid 305 are sorted differently in the vertical (top to bottom) direction. In particular, a sort-column 308 has been designated. The designation of the sort-column 308, which occurs via user interaction (discussed in greater detail below). In the revised heat map 360, the heat values 235 in column C4 have been sorted in ascending numerical order from top to bottom (with the cell(s) reflecting a minimum value 0% at the top and the cells reflecting a maximum value (>10%) at the bottom.

In particular, a revised sorting order is exhibited by the revised graphical grid 305 of the revised heat map 360. This may be seen in the row headings <Rn> on the vertical axis 215 of revised heat map 360. Thus, in the initial heat map 300 the row headings <Rn> are ordered in an ascending order R1, R2, . . . , R6, R7 which is an original sort order 320. In the revised heat map 360 the row headings are in a revised sort order 325 which, in the present exemplary case, happens to be R5, R2, R4, R3, R7, R6, R1. This revised sort order 325 corresponds to the revised vertical sorting order established for column C4.

Also illustrated in the heat map 360, the order of cells 210 in all columns 208 in addition to column C4 (i.e., in each of columns C1, C2, C3, C5, and C6) have also been reordered to match the newly established, revised sorting order 325 for column C4. This results in a reordering of entire rows 207, wherein the rows 207 of first exemplary heat map 300 are reordered vertically into second exemplary heat map 360 in such a way that the vertical ordering of cells 210 in selected column (C4) is in ascending order. The entire revised heat map 360 may then be displayed on display 170.

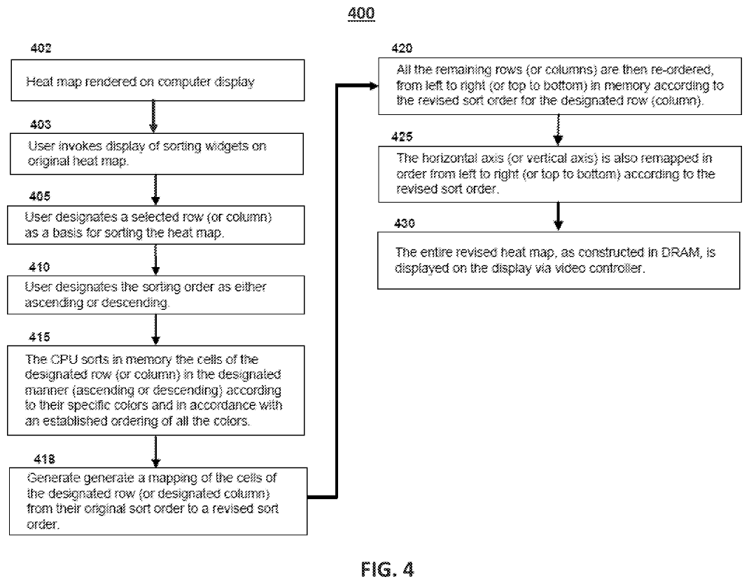

FIG. 4 is a flow chart of an exemplary method 400 a practicing an embodiment of the present disclosure. The method 400 entails sorting the initial heat map 300 by using a selected row 207 as a basis for sorting the columns 208 of the heat map 300.

The method 400 begins with action 402, where initial heat map 300 is rendered by the computer system 100 on the display 170. In an embodiment, the initial heat map 300 may be based on data stored in the tables 140.

In action 403, via the user interface 175, a user invokes the display of sorting widgets 510.A/B, 515, 525 (FIG. 5 below) on the display 170. In action 405, and employing the displayed sorting widget 510.A/B, 515, 525, the user indicates a particular designated row 308, from among the multiple rows 207 of the initial heat map 300.

In action 410, and employing the sorting widget 510.A/B, 515, 525, the user indicates that the cells 210 in the designated row should be sorted according to either ascending order (lowest value at the left, increasing values from left to right) or descending order (highest value at the left, decreasing values from left to right).

In action 415, and according to instructions and algorithms provided by code modules 145, the CPU 110 sorts in the DRAM 125 the cells 210 of the designated row in the designated manner (ascending or descending), according to (i) an established color order 520 (FIG. 5), for example, from lightest to darkest, or as may be indicated in the legend 225 and (ii) the specific colors 230 in the cells 210. The color order 520 may also be referred to as a data indicia order.

In action 418, the CPU 110 generates a mapping order specific to that designated row. The mapping order (e.g., stored in DRAM 125) generates a mapping of the cells of the row from their original sort order to a revised sort order. Thus, in an exemplary instance, an original horizontal default cell sort order of 1 2 3 4 5 6 from left to right might be mapped to a revised horizontal cell sort order of 5 6 2 3 1 4.

Not shown in the figures, but distinguished here by way of further explanation: In the initial presentation of the heat map, and in any given row, each cell 210 can be assigned a pair of numbers, such as (position 1, cell #1), (p2, #2), (p3, #3), (p4, #4), (p5, #5), and (p6, #6), or generally: (position [from left to right], cell identifier [a unique identifier for the cell]).

In the typical case where the cells are actually re-ordered, the mapping of the cells can be represented by pairing the cell positions with different cell identifiers. In the example above, this mapping order would result in a cell mapping of (position 1, cell #5), (p2, #6), (p3, #2), (p4, #3), (p5, #1), and (p6, #4). Similar mapping considerations can be applied to columns 208 and the mapping order of cells 210 in column 208.

In action 420, all the remaining rows 207 are then sorted, from left to right, according to the same revised mapping order. The mapping order may also be understood as a mapping of an initial position of each data indicia to a revised position of each data indicia. For the exemplary case in the sections above, for each row 207 in addition to the designated row 308, each cell 210 in initial position p1, p2, p3, p4, p5, p6 is mapped (moved) to cell positions p5, p6, p2, p3, p1, p4, respectively, as also shown inline immediately below.
Default left-to-right sort order: [1][2][3][4][5][6] is mapped or moved to: ▾
Revised left-to-right sort order: [5][6][2][3][1][4]

in the example, each of the cells contains one specific color 230 representative of a specific heat value 235 (or specified continuous range of heat values). Thus, changing the horizontal ordering of the cells 210 will result in a revised graphical display for colors 230 (and so for heat values 235).

In action 425, the horizontal axis 220 is also remapped in order from left to right according to the revised sort order.

In action 430, the entire revised heat map 360 is then rendered on the display 170 via the video controller 120. In an embodiment, when the revised heat map 360 is displayed, it may completely replace the initial heat map 300 on the display 170. In an alternative embodiment, the revised heat map 360 may be displayed in addition to the initial heat map 300. In yet another alternative embodiment, the computer system 100 may generate a new display window for presentation of the revised map 360.

The use of ordering directions “left to right” or “top to bottom” is for convenience only, by way of convenient description. Cells and rows may just as well be ordered from “bottom to top”, and/or cells and columns may just as well be ordered from “right to left” consistent with the displays illustrated, the essential processes of the methods described, and the appended claims. The choice of “left to right” “right to left,” or “top to bottom” or “bottom to top” may be hard-coded into the system or may be user-selectable.

Ordering processes are typically associated with numbers, while heat maps 200, 300, 360 present values in the form of colors 230. To perform a sorting operation (whether ascending or descending) that reflects the proper ordering of the colors 230 and is numerically based, the CPU 110 may perform an ordering operation among the colors 230. This color ordering operation may represent an association between specific colors 230 and specific numerical values usable in a sorting algorithm.

In some embodiments, a default color order 520 (FIG. 5 below) is provided for by the legend 225, or by internal data such as heat values 235 which is associated with the construction of an association between each specific color 230 and a specific heat value 235 or range of heat values 235.

In exemplary heat maps 200, 300, 360, 500, cell colors 230 and heat values 235 are associated by a color order 520 according to Green←→0; Yellow←→1-3; Orange←→4-10; and Red←→>10. As a result, the colors Green, Yellow, Orange, and Red can be sorted according to (disjointed) values or value ranges of 0, 1-3, 4-10, and >10. For purposes of sorting algorithms, a single particular numerical value, within the appropriate range, can be assigned to each particular color. In the present example, Green may be assigned the value of 0, Yellow assigned the value of 2, Orange assigned the value of 4, and Red assigned the value of 11. Other possible color/number assignments, understood by those of skill in the art, may be used and are within the spirit and scope of the present disclosure.

In an alternative embodiment, and possibly a function of coding languages used, it may be possible to employ a coding language construct (an ordering function or a data structure) to directly assign a color order 520 for sorting purposes. In hypothetical pseudocode, for example, a programming construct similar to the following may be possible:
define group Colors (Green, Yellow, Orange, Red);
//creates colors, with a default color ordering

If the command which creates the colors does not create a color default ordering, then an ordering may be assigned with an exemplary command such as:
Colors.ordering(ascending; Green, Yellow, Orange, Red);
//assigns an ordering for the colors for use in sorting
//algorithms, for example yellow>green, orange>yellow, etc.

Sorting may then be done according, in an exemplary embodiment, according to an exemplary program pseudocode which may be similar to the following:
arrayName=MyHeatMap; index=3; property=Colors;
SortingMap=order.row(arrayName, index, property, ascend);
//orders the cells of row 3 according to stored colors
//in ascending order, and also creates a sorting map

where HeatMap may be a suitable array or table structure, the command selects for row 3 in the array, and sorts row 3 in ascending column order by the Colors attribute. The order.row( ) function may additionally return a suitable data structure (such as possibly an array) which provides an indication of the mapping from the original sort order 320 to the revised sort order 325.

In another alternative embodiment, cell colors 230 may be re-ordered directly according to an established color mapping system or color ordering system, such as Red Green Blue (RGB), Munsell Color Order System, Pantone System, or some other color organization or ordering system. The choice of ordering system (e.g., the color order 520) may be hard-coded, modifiable, or may be user-selectable (see discussion related to FIG. 5 below).

In various embodiments, a variety of sorting algorithms may be employed for re-ordering the cells in a row or column; these may include, for example and without limitation: selection sort, bubble sort, insertion sort, merge sort, quick sort, and others.

Reordering a row 207 or column 208 according to either of ascending order or descending order will inherently cause like-colored cells 210 (in that row or column) to be clustered together adjacent to each other (within that row or column). For some colors, there are at least two cells 210 of the same color 230 in the row 207 or column 208. One such color cluster 350 is depicted in FIG. 3.

FIG. 5 presents another exemplary heat map 500, according to the embodiments. The exemplary heat map 500 may be the same or substantially similar to the heat maps 200 and 300 discussed above. Accordingly, elements of the heat map 500 discussed in relation to the heat maps 200 and 300 above, will not be repeated in reference to the heat map 500 of FIG. 5.

The heat map 500 may have a number of sorting widgets 510.A/B, 515, 525 available, enabling a user of the heat map 500 to select a row 207 or column 208 for sorting. The sorting widgets also help determine whether a sort order is ascending or descending. These widgets 510.A/B, 515, 525 and actions are associated with actions 405 and 410 of exemplary method 400 above. By way of example, the sorting widgets 510.A/B, 515 may be presented as menus.

For example, a first sorting menu 510.A or a second sorting menu 510.B may be rendered on the display 170 by the user selecting a desired Sort Row or Column Heading 504. In various embodiments, any number of different user actions may be used to generate a user signal for the selection. For example, user actions may include hovering with the mouse pointer over the desired Sort Row or Column Heading 504, left- or right-clicking with the mouse on the desired Sort Row or Column Heading 504, or selecting the desired row heading or column heading via various cursor key action on the keyboard. If the display 170 is a touch screen, the first sorting menu 510.A or the second sorting menu 510.B may be activated simply by the user touching the appropriate Sort Row or Column Heading 504 on the display 170.

When the desired Sort Row or Column Heading 504 is suitably selected via a user action or signal, the system presents the appropriate first sorting menu 510.A or second sorting menu 510.B. The user may then select either of the options “Sort Ascending” or “Sort Descending”; the selection again being made via any number of appropriate mouse, keyboard, or touch screen signals/actions, as are known the art for selecting menu options.

In an alternative embodiment, the user selects a particular cell 210 in a desired row 207 or column 208 of graphical grid 205. The selected cell may be designated as the sort cell 502. Upon selection of the sort cell 502 by suitable mouse or keyboard actions, the system presents third sorting menu 515 on the display 170. Third sorting menu 515 may include options for sorting by row or by column, and for sorting either ascending or descending. The row 207 or column 208 selected as the basis for sorting will be the row or column which includes the sort cell 502.

As shown in FIG. 5, another form of sorting widget may be a modified or enhanced legend 525. The enhanced legend 525 is similar to the legend 225 discussed above, but with the addition of a Sort Order column 520. The Color Order column may include a series of text fields which correspond to colors 230. In the exemplary Color Order column 520, the color order by default may be 1, 2, 3, 4, corresponding in this exemplary case to colors Green, Yellow, Orange, and Red. However, via suitable keyboard actions, mouse actions, and/or touch screen actions, the default color order values may be changed (for example, to 4, 1, 2, 3, or some other sorting order designated by the user). A [Set] button 530 may be employed to accept or confirm user changes. Some benefits of the present system and method include, but are not limited to:

Turning a static data visualization into an interactive experience that encourages data exploration;

reducing the human short-term memory load needed to understand data relationships (by off-loading key visualization processes from the human brain to the computer system);
allowing users to focus in on data relationships of interest;
allowing users to identify the most important relationships for large data sets (large number of rows or columns) that would not be possible in a static view;
providing the ability to visualize and explore very large data sets than cannot be effectively viewed in numeric form on a display;
allowing users to refine the view based on their particular interest or elements they want to highlight; and
allowing users to export views depicting relationships they want to convey.

The subject matter of the claims is not limited to the implementations and illustrations provided herein, but include modified forms of those implementations including portions of implementations and combinations of elements of different implementations in accordance with the claims. It should be appreciated that in the development of any such implementation, as in any engineering or design project, numerous implementation-specific decisions should be made to achieve developers' specific goals, such as compliance with system-related and business related constraints, which may vary from one implementation to another. Moreover, it should be appreciated that such a development effort may be complex and time consuming, but would nevertheless be a routine undertaking of design, fabrication, and manufacture for those of ordinary skill having benefit of this disclosure.

Described herein are various implementations of a method. The terminology used in the description of the disclosure provided herein is for the purpose of describing particular implementations and is not intended to limit the disclosure provided herein. As used in the description of the disclosure provided herein and appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify a presence of stated features, integers, actions, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. The terms “up” and “down”; “upper” and “lower”; “upwardly” and “downwardly”; “below” and “above”; and other similar terms indicating relative positions above or below a given point or element may be used in connection with some implementations of various technologies described herein.

While the foregoing is directed to implementations of various techniques described herein, other and further implementations may be devised in accordance with the disclosure herein, which may be determined by the claims that follow.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method comprising:
rendering, via a computer processor, a heat map including a vertical axis with a first data range, a horizontal axis (i) with a second data range and (ii) orthogonal to the vertical axis, and a plurality of cells arranged in an initial grid along the vertical and horizontal axes,
wherein each cell of the plurality of cells displays a data indicia indicative of a results data value responsive to (i) a first data value within the first data range and (ii) a second data value within the second data range, the plurality of cells being arranged in a plurality of rows and columns;
selecting, via the computer processor, one of a single sorting column or a single sorting row of the initial grid;
sorting the plurality of cells of the selected single sorting column or the single sorting row according to a data indicia order, the sorting generating a mapping order;
sorting in the initial grid, according to the generated mapping order, one of (i) each column of the initial grid different than the single sorting column, or (ii) each row of the initial sorting grid different than the single sorting row; and
rendering a revised grid via the processor, the revised grid including at least a portion of the initial grid.

2. The method of claim 1, wherein (i) each row of the initial graphical grid is displayed in an order sorted according to the mapping order, or (ii) each column of the initial graphical grid is displayed in an order sorted according to the mapping order; and
wherein the sorting is from an initial order to one of an ascending order and a descending order.

3. The method of claim 2, further comprising accepting via a sorting widget of the computer system a user signal indicative that the sorting order should be one of the ascending sort order and the descending sort order.

4. The method of claim 1, wherein the data indicia comprises a color of the graphical cell, a texture of the graphical cell, or an icon of the graphical cell.

5. The method of claim 1, wherein the data indicia order is determined according to at least one of a hard-coded ordering of the data indicia, a legend of the data indicia, a value or range of values associated with an individual data indicia, and a user-indicated ordering of the data indicia.

6. The method of claim 1, wherein generating the mapping order comprises determining an association between an initial position of a data indicia and a revised position of the data indicia.

7. A computer-readable, non-transitory storage medium storing instructions that, when executed by a central processing unit (CPU) of a computer system causes the CPU to execute a method comprising:
presenting via a video controller of the computer system on a display of the computer system a heat map comprising a vertical axis with a first data range, a horizontal axis with a second data range and which is orthogonal to the vertical data axis, and a plurality of graphical cells arranged in an initial graphical grid along the vertical axis and the horizontal axis, wherein:
each graphical cell of the initial graphical grid displays a data indicia which is indicative of a results data value which is a function of both a first data value within the first data range and a second data value within the second data range; and
the plurality of graphical cells of the initial graphical grid are arranged in a plurality of rows and columns;
accepting via a user interface of the computer system a user signal which selects for one of a single sorting column or a single sorting row of the initial graphical grid;
sorting via the CPU a plurality of cells of the single sorting column or the single sorting row according to a data indicia order;
generating via the sorting process a mapping order established according to sorting of the single sorting column or the single sorting row;
sorting in the initial graphical grid, and according to the mapping order, one of: (i) each column of the initial graphical grid which is other than the single sorting column, or (ii) each row of the initial sorting grid which is other than the single sorting row; and
presenting via the video controller on the display the revised graphical grid, wherein:
the revised graphical grid comprises the initial graphical grid with either: (i) each row of the initial graphical grid displayed in an order sorted according to the mapping order, or (ii) each column of the initial graphical grid displayed in an order sorted according to the mapping order.

8. The computer-readable, non-transitory storage medium of claim 7, storing further instructions wherein the method further comprises sorting the initial graphical grid from an initial order to one of an ascending sort order and a descending sort order.

9. The computer-readable, non-transitory storage medium of claim 8, storing further instructions wherein the method further comprises accepting via a sorting widget of the computer system a user signal indicative that the sorting order should be one of the ascending sort order and the descending sort order.

10. The computer-readable, non-transitory storage medium of claim 7, storing further instructions wherein the displaying the data indicia comprises displaying a color of the graphical cell, displaying a texture of the graphical cell, or displaying an icon of the graphical cell.

11. The computer-readable, non-transitory storage medium of claim 7, storing further instructions wherein the method further comprises determining the data indicia order according to at least one of a hard-coded ordering of the data indicia, a legend of the data indicia, a value or range of values associated with an individual data indicia, and a user-indicated ordering of the data indicia.

12. The computer-readable, non-transitory storage medium of claim 7, storing further instructions wherein the method further comprises generating the mapping order as an association between an initial position of the data indicia and a revised position of the data indicia.

13. A system comprising:
a central processing unit (CPU), a memory, a video controller, a user interface, and a display, wherein the memory is configured to store instructions which direct the CPU to:
present via the video controller on the display a heat map comprising a vertical axis with a first data range, a horizontal axis with a second data range and which is orthogonal to the vertical data axis, and a plurality of graphical cells arranged in an initial graphical grid along the vertical axis and the horizontal axis, wherein:
each graphical cell of the initial graphical grid displays a data indicia which is indicative of a results data value which is a function of both a first data value within the first data range and a second data value within the second data range; and
the plurality of graphical cells of the initial graphical grid are arranged in a plurality of rows and columns;
accept via the user interface of the computer system a user signal which selects for one of a single sorting column or a single sorting row of the initial graphical grid;
sort via a central processing unit of the computer system a plurality of cells of the single sorting column or the single sorting row according to a data indicia order;
generate via the sort process a mapping order established according to the sorting of the single sorting column or the single sorting row;
sort in the initial graphical grid, and according to the mapping order, one of: (i) each column of the initial graphical grid which is other than the single sorting column, or (ii) each row of the initial sorting grid which is other than the single sorting row; and
presenting via the video controller on the display the revised graphical grid, wherein:
the revised graphical grid comprises the initial graphical grid with either: (i) each row of the initial graphical grid displayed in an order sorted according to the mapping order, or (ii) each column of the initial graphical grid displayed in an order sorted according to the mapping order.

14. The system of claim 13, wherein the memory is further configured to store instructions which direct the CPU to sort the initial graphical grid from an initial order to one of an ascending sort order and a descending sort order.

15. The system of claim 14, wherein the memory is further configured to store instructions which direct the CPU to obtain via a sorting widget of the computer system a user signal indicative that the sorting order should be one of the ascending sort order and the descending sort order.

16. The system of claim 13, wherein the memory is further configured to store instructions which direct the CPU to display the data indicia, via the video controller, as a color of the graphical cell, a texture of the graphical cell, or an icon of the graphical cell.

17. The system of claim 13, wherein the memory is further configured to store instructions which direct the CPU to determine the data indicia order according to at least one of a hard-coded ordering of the data indicia, a legend of the data indicia, a value or range of values associated with an individual data indicia, and a user-indicated ordering of the data indicia.

18. The system of claim 13, wherein the memory is further configured to store instructions which direct the CPU to generate the mapping order as an association between an initial position of the data indicia and a revised position of the data indicia.
